(19) United States
(12) Patent Application Publication
(10) Pub. No.: US 2008/0170533 A1
(43) Pub. Date: Jul. 17, 2008

(54) Near-field spatial multiplexing

(76) Inventors: Haruch Cyzs, Kiryat Motzkin (IL); Haim Grinberger, Kiryat Tivon (IL)

Correspondence Address: Abelman Frayne & Schwab, 666 Third Avenue, New York, NY, 10017-5621, US

(21) Appl. No.: 10/504,469

(22) PCT Filed: Feb. 12, 2003
(86) PCT No.: PCT/IL03/00108

§ 371 Date: Apr. 17, 2006

Related U.S. Application Data
(60) Provisional application No. 60/356,985, filed on Feb. 13, 2002.

(30) Foreign Application Priority Data
Sep. 25, 2002 (IL) 151937

(51) Int. Cl. H04J 3/08; H04J 1/10

(52) U.S. Cl. 370/315

(57) ABSTRACT

Wireless communication apparatus (20) includes a transmitter (22), which includes a first plurality of transmit antennas (26) mutually separated by a first spacing, and which is configured to transmit signals via the transmit antennas over multiple spatial sub-channels, the signals having respective phases. A receiver (24), which includes a second plurality of receive antennas (28) mutually separated by a second spacing, is configured to receive the signals over the multiple spatial sub-channels via the receive antennas. The first and second spacings are chosen so as to maximize a linear independence of the respective phases of the signals received at the receive antennas.

### CROSS-REFERENCE TO RELATED APPLICATION

This application claims the benefit of U.S. Provisional Patent Application 60/356,985, filed Feb. 13, 2002, which is incorporated herein by reference.

### FIELD OF THE INVENTION

The present invention relates generally to wireless communications, and specifically to methods and systems for increasing wireless link capacity by using multiple antennas.

### BACKGROUND OF THE INVENTION

Spatial diversity is a well-known method for increasing the capacity and reliability of wireless links. Typically, for diversity purposes, a wireless receiver is equipped with multiple antennas, which are spaced a certain distance apart. The signals received by the different antennas vary due to environmental conditions, such as fading and multi-path effects. The receiver takes advantage of these differences to compensate for degradation that may occur as the signals travel from the transmitter to the receiver, thereby increasing the effective rate at which the receiver is able to receive data. In addition, the redundant antenna in the receiver provides a backup in case of failure. Transmitters may be equipped with redundant antennas for the same reasons.

U.S. Pat. No. 6,058,105, whose disclosure is incorporated herein by reference, describes a method for increasing the bit rate of a wireless communication channel using multiple transmit and/or receive antennas. The transmitter and receiver determine a matrix of propagation coefficients characterizing the propagation of communication signals between the different transmitting and receiving antennas. The matrix is decomposed at the receiver, using singular value decomposition (SVD), into the product of a diagonal matrix and two unitary matrices. Each diagonal matrix element corresponds to a parallel, independent virtual sub-channel of the actual transmission channel. The receiver passes the elements of the diagonal matrix and one of the unitary matrices back to the transmitter, which uses these matrices to encode and modulate an incoming information stream onto the virtual sub-channels. The system thus increases the capacity of the actual communication channel by dividing it into parallel independent sub-channels within the same frequency band. The stronger sub-channels (corresponding to the higher-valued diagonal matrix elements) are used to transmit more information than the weaker sub-channels.

Polarization diversity may also be used to increase the rate of information carried over a wireless link. For example, U.S. Pat. No. 5,691,727, whose disclosure is incorporated herein by reference, describes an adaptive polarization diversity system, in which the transmitter polarized signals. The receiver includes two antennas, one for each of two possible orthogonal polarizations, and combines the polarized signals that it receives according to weighting factors that it determines adaptively. This method can be extended to provide two parallel communication channels over the same link, with orthogonal polarizations, thus doubling the link capacity.

U.S. Pat. No. 6,144,711, whose disclosure is also incorporated herein by reference, describes a space-time processing system that can be used with a system having multiple transmit and/or receive antennas and/or multiple polarizations. The system takes advantage of multi-path effects to gain a multiplicative increase in capacity. It uses a technique referred to in this patent as a substantially orthogonalizing procedure (SOP) to decompose the time-domain space-time communication channel into a set of parallel, space-frequency SOP bins. The signal received at the receiver in one SOP bin is said to have reduced inter-symbol interference (IS) and to be substantially independent of the signal received in any other bin. As a result, spatial processing techniques can be used efficiently to optimize performance of the system.

### SUMMARY OF THE INVENTION

In multi-antenna communication links known in the art, the necessary diversity of the received signals is provided by environmental conditions (multi-path reflection effects and fading) that are difficult or impossible to predict. As a result, the virtual sub-channels created in such diversity systems must be determined adaptively. The sub-channels typically have different relative signal strengths, which cannot be controlled by the operator. Furthermore, in high-frequency point-to-point transmission systems—which operate in the range of 10 GHz and above - the practical distance range of transmission through the atmosphere is severely limited. Therefore, multi-path reflection effects are of little use in creating diversity in such systems.

Preferred embodiments of the present invention provide a method for deterministically creating multiple spatial sub-channels on a wireless communication link, which overcomes these deficiencies of the prior art. The present invention uses near-field beam propagation geometry to determine the relative spacing of multiple transmit and receive antennas. The spacings between the antennas at the transmit and receive sides of the link are chosen so as to orthogonalize the phases of the signals received at each of the receive antennas from each of the transmit antennas. In other words, the antenna spacings are set, based on the distance between the transmitter and receiver and the transmitted signal wavelength, so as to provide maximal phase diversity between the signals carried from each of the transmitters to each of the receivers, without reliance on multi-path effects. The positions of the antennas can be chosen in this fashion so as to create the spatial sub-channels deterministically, with optimal information-carrying capacity.

The numbers and spacings of the transmit and receive antennas may be equal, or they may be different. The spacings may be set to give roughly equal gain in all sub-channels, or to favor one sub-channel over another. As a general rule, in order to provide near-field orthogonalization, the product of the spacing of the transmit antennas d_{T} by the spacing of the receive antennas d_{R} should be of the same order of magnitude as the product of the transmission wavelength λ by the distance R between the transmitter and the receiver, divided by the number of antennas N. In more quantitative terms, d_{T}d_{R} should be roughly between one third and three times λR/N. Optimally, d_{T}d_{R} is set to be roughly equal to λR/N, but sub-optimal spacing (particularly spacing that is slightly less than the optimum) may be used to accommodate constraints on antenna placement or other system requirements.

In some preferred embodiments of the present invention, useful particularly in symmetrical point-to-point links, the transmit and receive antennas are equal in number and are approximately equally spaced, and the number of spatial sub-channels used is equal to the number of antennas. In other preferred embodiments, the numbers and/or spacing of transmit and receive antennas may be different. Such configurations may be useful in multi-node network topologies, for example, in which a hub communicates with multiple spokes by means of multiple point-to-point links or a point-to-multipoint link. For reasons of convenience, the hub antennas may typically be more widely spaced than the spoke antennas. The principles of the present invention may be applied in other wireless network topologies, as well, such as ring networks.

Furthermore, the number of spatial sub-channels may be less than the number of transmit antennas or receive antennas. Substantially any desired number of spatial sub-channels may be used, as long as the number of spatial sub-channels is no greater than the lesser of the number of transmit antennas and the number of receive antennas. Each spatial sub-channel will have a spatial diversity gain that is proportional to the numbers of transmit and receive antennas, and inversely proportional to the number of sub-channels.

As a further option, the transmit and receive antennas may be polarized to provide two orthogonal polarizations. Each polarization direction is treated as a separate sub-channel for processing purposes, thus increasing further the capacity of the link. Typically, each transmit antenna has its own transmit circuits, including a modulator and up-converter, and each receive antenna has its own receive circuits, including a down-converter and demodulator. Preferably, all the transmit circuits share a common local oscillator and timing signals, and all the receive circuits likewise share a common local oscillator and carrier and clock recovery circuits. The use of common timing circuits in this manner is not only economical, but it also prevents spurious variations in the transfer functions of different sub-channels that could arise due to relative clock drift between the different transmit or receive circuits.

Even when the antenna positions are optimally chosen and timing is properly controlled, environmental conditions and other effects may cause some deviation from orthogonality of the received signals. Therefore, in some preferred embodiments of the present invention, the receiver analyzes the signals, preferably by singular value decomposition (SVD), to determine beam-forming parameters that optimize the separation of the spatial sub-channels. Some of these parameters are preferably conveyed back to the transmitter for use in transforming the spatial sub-channel signals into physical sub-channel signals, each of which is transmitted by a respective antenna. The use of SVD, with beam-forming at both transmitter and receiver, optimizes the separation of the sub-channels without increasing the noise levels, thus maximizing the overall capacity of the communication link.

Additionally or alternatively, the receiver may compute and apply its own beam-forming parameters, without conveying parameters back to the transmitter. For this purpose, the receiver preferably uses QR decomposition to separate the received signals into orthogonal sub-channels.

In a preferred embodiment, the receiver first determines beam-forming parameters using the SVD method, and conveys the parameters to be applied by the transmitter as described above. The receiver then continues to track and analyze the signals using QR decomposition, and modifies its own beam-forming parameters accordingly. It is generally possible to update the transmitter parameters less frequently than the receiver parameters, since the transmitter parameters essentially affect only the diversity gain of the sub-channels, and not the sub-channel separation. When the receiver detects a deviation from orthogonality of the sub-channels that cannot be corrected by beam-forming at the receiver alone, however, the receiver determines new parameters for both the transmitter and the receiver, preferably using SVD, and then conveys the new transmitter parameters back to the transmitter. Alternatively, the receiver may simply update the SVD parameters periodically, at predetermined intervals. This combined SVD/QR beam-forming method enables the receiver to adapt rapidly to changes in the sub-channels, without requiring constant updating of the transmitter parameters.

In some preferred embodiments of the present invention, the spatial sub-channels are further divided into frequency sub-carriers, or bins, preferably using orthogonal frequency division multiplexing (OFDM). An advantage of this approach, as opposed to single-carrier modulation, is that it allows the receiver to calculate and implement beam-forming parameters independently for each frequency bin, thus taking into account any frequency-dependent effects that may occur. Preferably, in order to determine the beam-forming parameters, the transmitter transmits a sequence of predetermined training symbols. Each symbol in the sequence is most preferably made up of pilot signals that are scattered among the different sub-channels and sub-carriers in a pattern, preferably an orthogonal pattern, known to the receiver. The sequence of symbols is designed to cover all the sub-carriers in all the sub-channels. Preferably, the transmitter interleaves the training signals, at known intervals, with frames of payload data that it transmits, so that the receiver can continually update its beam-forming parameters for all the sub-carriers and sub-channels.

Typically, the spatial sub-channels carried over the wireless link may have different signal/noise ratios. Based on the respective signal/noise ratios, the sub-channels may be configured to carry data at different rates by using different modulation and encoding rates. Preferably, the antenna positions and beam-forming parameters are chosen so that the capacity of the link is distributed among the different sub-channels in a desired manner, either equally or unequally. Most preferably, the transmitter distributes its input data stream among the spatial sub-channels on the basis of the specific sub-channel signal/noise ratios and data rates. For example, the transmitter may fragment- a single data stream among multiple sub-channels by inverse multiplexing of the data stream among the sub-channels, as known in the art. Alternatively, the transmitter may receive multiple input data streams, and may assign them to different sub-channels based on rate or QoS requirements.

Preferably, the transmitter sends payload data to the receiver in frames that have an identifying header and error correcting codes. If the receiver determines that a frame has been lost or damaged beyond correction, the receiver may send an automatic repeat request (ARQ) over a reverse channel to the transmitter. Even if the frame was originally sent over a low-quality sub-channel, the transmitter preferably retransmits the requested packet over a high-quality sub-channel. This division of traffic among high- and low-quality sub-channels allows the total available link bandwidth to be optimally exploited.

Typically, the individual data rates of all the sub-channels are set so that the total payload capacity of the wireless link meets a predetermined target. The data rate of each sub-channel is determined by its modulation level (number of bits/symbol) and coding gain (for forward error correction—FEC), which are preferably set individually for each sub-channel depending on the signal/noise ratio of the sub-channel. Preferably, when OFDM is used, different modulation levels can be applied to different sub-carriers, as well. The modulation level and coding gain are set for each sub-channel so as to ensure that the BER of the sub-channel will be no less than some minimum value, which may vary depending on the type of traffic that the sub-channel is to carry. Most preferably, the individual sub-channel rates are chosen so that all sub-channels maintain the maximum possible gain margin that allows the link to satisfy the target total capacity.

In some preferred embodiments of the present invention, a multi-antenna system is configured to provide active redundancy, using multiple spatial sub-channels. In this configuration, the number of transmit and receive antennas is chosen to be greater than what is required to carry the expected link payload under normal conditions. If one of the antennas fails (typically due to failure of the transmit or receive circuits connected to the antenna), the transmitter and receiver automatically reconfigure the spatial sub-channels and redistribute the link payload so that it is carried by the remaining antennas. On the other hand, as long as all the antennas are working normally, the excess link capacity allows the transmitter and receiver to operate at a low modulation level and/or high coding gain on all the sub-channels, so that the sub-channels normally enjoy a high gain margin.

As a result of this high gain margin, the transmitter and receiver may be positioned relatively far apart. Even in bad weather, the signal level reaching the receiver will still be adequate, given the tolerant modulation and coding settings. When one of the antennas fails, the modulation level of the remaining spatial sub-channels is increased, and/or the coding gain is decreased, so that the link can still carry its full payload. The link rate will have to be reduced only in the unlikely occurrence of simultaneous antenna failure and bad weather. The active redundancy approach of the present invention thus enables the system operator to recoup at least a portion of the investment required in redundant transmission capacity, by using the redundant capacity to give increased link range. This approach is applicable not only to the near-field antenna configurations described herein, but also to other multi-antenna links that use multiple spatial sub-channels.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a wireless link with multiple transmit and receive antennas, in accordance with a preferred embodiment of the present invention;

FIG. 2A is a schematic, geometrical representation of a set of transmit and receive antennas, useful in understanding the principles of the present invention;

FIG. 2B is a schematic, geometrical representation of a set of receive antennas, in accordance with another preferred embodiment of the present invention;

FIG. 3A is a plot showing gains of spatial sub-channels in the system of FIG. 1 as a function of spacing between the antennas;

FIG. 3B is a plot showing the total data capacity of the wireless link of FIG. 1 as a function of spacing between the antennas;

FIG. 4 is a block diagram that schematically illustrates a transmitter with multiple antennas, in accordance with a preferred embodiment of the present invention;

FIG. 5 is a block diagram that schematically illustrates a receiver with multiple antennas, in accordance with a preferred embodiment of the present invention;

FIG. 6 is a block diagram that schematically shows details of spatial channel processing circuitry in the transmitter of FIG. 4, in accordance with a preferred embodiment of the present invention;

FIG. 7 is a block diagram that schematically shows details of physical channel processing circuitry in the transmitter of FIG. 4, in accordance with a preferred embodiment of the present invention;

FIG. 8 is a block diagram that schematically shows details of physical channel processing circuitry in the receiver of FIG. 5, in accordance with a preferred embodiment of the present invention;

FIG. 9 is a block diagram that schematically shows details of spatial channel processing circuitry in the receiver of FIG. 5, in accordance with a preferred embodiment of the present invention;

FIG. 10 is a flow chart that schematically illustrates a method for setting gain margins of multiple spatial sub-channels, in accordance with a preferred embodiment of the present invention;

FIG. 11 is a flow chart that schematically illustrates a method for retransmission of a data frame, in accordance with a preferred embodiment of the present invention; and

FIG. 12 is a schematic view of a wireless system for point-to-multipoint transmission, in accordance with a preferred embodiment of the present invention.

### DETAILED DESCRIPTION OF PREFERRED EMBODIMENTS

### System Overview

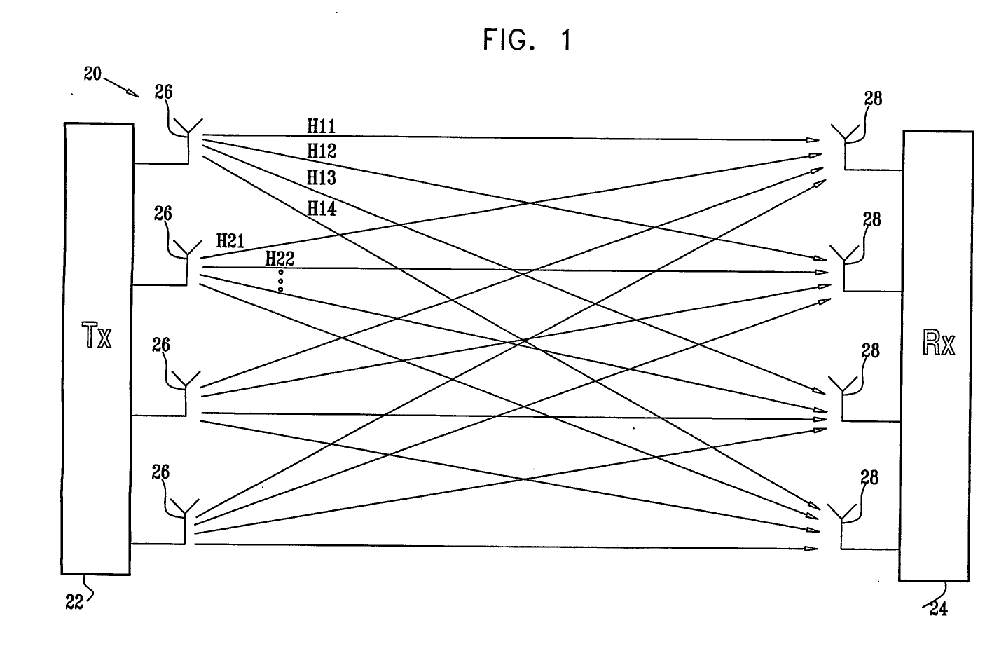

FIG. 1 is a block diagram that schematically illustrates a wireless data transmission system 20, in accordance with a preferred embodiment of the present invention. System 20 comprises a transmitter 22 and a receiver 24, which are connected by a wireless link formed by multiple transmit antennas 26 and receive antennas 28. Each of the receive antennas receives signals from all the transmit antennas, with amplitude and phase determined by a complex channel transfer function matrix H, having elements H₁₁, H₁₂, . . . , as shown in the figure. In other words, the transmitted signal vector x and the received signal vector y (made up of the individual complex signals xᵢ and yⱼ transmitted and received by the different antennas 26 and 28) are related by the expression:

y=Hx+n (1)

Here n represents the noise received at each antenna. Hᵢⱼ is the complex transfer function from transmit antenna i to receive antenna j, and represents generally both amplitude attenuation and relative phase delay in propagation of signals between these particular transmit and receive antennas.

If the rows and columns of H can be made linearly independent of one another, it is then possible to define multiple, independent spatial sub-channels between transmitter 22 and receiver 24, all sharing the same frequency band. The number of available sub-channels is equal to the lesser of the column-rank and row-rank of H, and the gain of each channel is proportional to the singular value of the corresponding row or column. It can be shown that the overall capacity of the wireless link between transmitter 22 and receiver 24 is maximized when the gains of all the sub-channels are equal.

### Maximum Orthogonality of Near-Field Spatial Sub-Channels

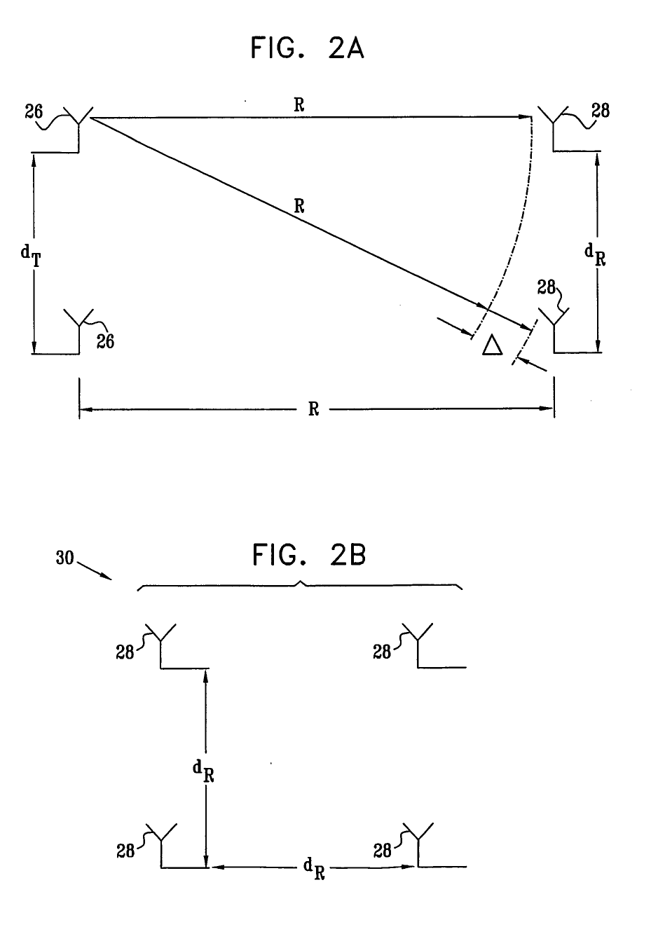

FIG. 2A is a schematic, geometrical representation of two transmit antennas 26 and two receive antennas 28, which will be useful in understanding the principles of the present invention. As shown in this figure, transmit antennas 26 are mutually separated by a transmit antenna spacing d_{T}, while receive antennas 28 are separated by a receive antenna spacing d_{R}. The distance from the transmitter to the receiver is R. Because of the mutual spacing of the antennas at the transmit and receive ends of the link, however, the distance between a given transmit antenna and different receive antennas varies by an increment Δ, which is proportional to the product of the antenna spacings d_{T}d_{R}. In the near field, i.e., when Δ is roughly on the order of λ/4 or greater (wherein λ is the transmission wavelength), the differences in path lengths among the different pairs of transmit and receive antennas are significant in determining the respective phase delays of the different Hᵢⱼ matrix elements. To achieve the desired path length differences, the transmit and receive antennas may be mutually spaced in substantially any direction, and not only vertically as shown in this simplified figure.

Referring back to FIG. 1, and assuming the mutual spacings between the transmit antennas and between the receive antennas are equal, the channel transfer function of system 20 (neglecting attenuation) can be expressed as follows:

$$H = [ \begin{matrix}1 & {e}^{- j ϕ} & {e}^{- 4 j ϕ} & {e}^{- 9 j ϕ} \\ {e}^{- j ϕ} & 1 & {e}^{- j ϕ} & {e}^{- 4 j ϕ} \\ {e}^{- 4 j ϕ} & {e}^{- j ϕ} & 1 & {e}^{- j ϕ} \\ {e}^{- 9 j ϕ} & {e}^{- 4 j ϕ} & {e}^{- j ϕ} & 1\end{matrix} ] \qquad ( 2 )$$

Assuming for simplicity that d_{T}=d_{R}=d, the phase shift φ is equal to πd²/λR.

FIG. 2B is a schematic geometrical representation of an array 30 of four receive antennas 28, in accordance with another preferred embodiment of the present invention. In this case, the antennas are arranged in a square, rather than in a linear row as shown in FIG. 1. It will be observed that the analysis of different phase delays among the different antennas applies to array 30, as well. In fact, the principles of the present invention may be applied using substantially any arrangement of the transmit and/or receive antennas in which the antennas are located at or near the vertices of a regular polygon.

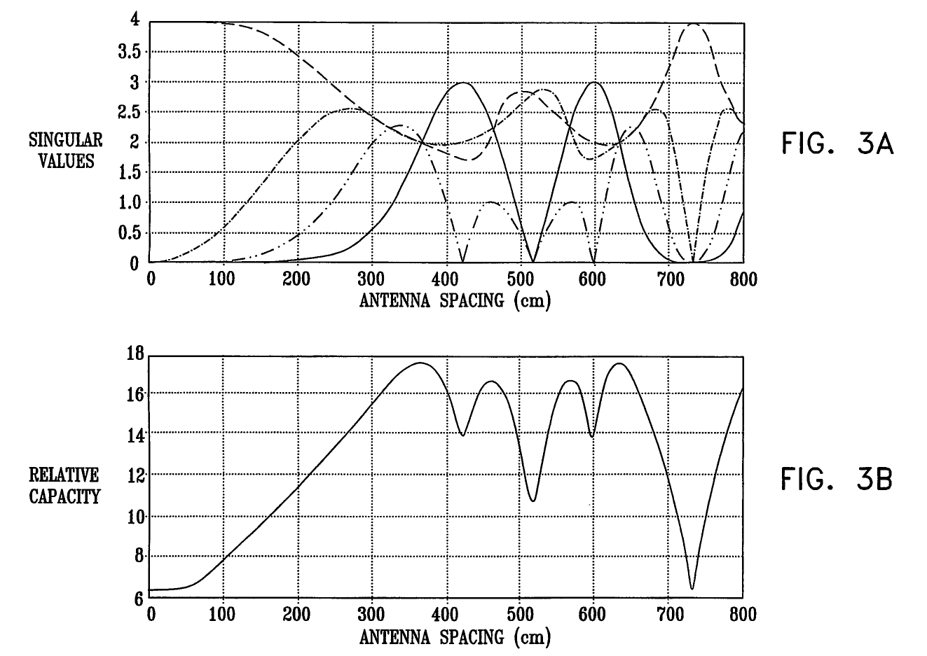

FIG. 3A is a plot showing the relative gains of four spatial sub-channels created in system 20, as given by the singular values of the rows (or columns) of matrix H shown in equation (2). In general, each of the spatial sub-channels on the link between transmitter 22 and receiver 24 is made up of a weighted mixture of signals transmitted between a number of pairs of transmit antennas 26 and receive antennas 28. Each such pair is represented by a matrix element Hᵢⱼ. The spatial sub-channels may be separated by the well-known procedure of singular value decomposition (SVD), applied to equation (2):

H=UΣV^{t} (3)

wherein U and V are complex unitary matrices, and Σ is a real diagonal matrix. The superscript “t” indicates that the Hermitian conjugate is taken of matrix V. (For unitary matrices, VₜV=I, the identity matrix.) The diagonal elements σᵢ of Σ are the respective gains of the spatial sub-channels.

As long as environmental effects (such as fading and reflections) are ignored, the matrices U, Σ and V are completely determined by the geometrical positioning of the transmit and receive antennas. The gains of the spatial sub-channels are shown on this basis in FIG. 3A as a function of the antenna spacing d, for a distance R=5000 m between transmitter 22 and receiver 24, and a transmission frequency of 28 GHz (λ≅1 cm).

FIG. 3B is a plot showing the total data capacity of the wireless link between transmitter 22 and receiver 24, as a function of the antenna spacing d. The total capacity is calculated relative to the Shannon bound for a single sub-channel, assuming a uniform noise level on all sub-channels. The maximum capacity is achieved when the singular values of all the sub-channels are the same. When this condition is met, the phase-orthogonality of the spatial sub-channels is maximized. This requirement is satisfied when the spacings of the transmit and receive antennas meet the condition:

$${d}_{T} \cdot {d}_{R} = {( \frac{λ}{2 N} )}^{2} ( 1 + \frac{4 NR}{λ} ) \approx \frac{λ R}{N} \qquad ( 4 )$$

Here N is the number of antennas. (f the transmitter and receiver have different numbers of antennas, N is the greater of the two numbers).

The condition of equation (4) is deterministically based on the geometrical parameters of the wireless link itself and does not depend on multi-path effects. In fact, in the near-field domain in which system 20 is designed to operate, reflections tend to degrade system performance by reducing the optimal orthogonality of the geometric placement of the antennas. Although maximal link capacity is attained by satisfying equation (4) exactly, it will be observed in FIG. 3B that small deviations from this condition degrade link capacity only slightly. Such a deviation may even be intentionally introduced in order to accommodate physical constraints on antenna installation. Furthermore, as seen in FIG. 3B, there are several peaks in the total capacity curve, and the antenna spacings in system 20 may be set to any of the peaks. Equation (3) refers to the peak at which the antennas are spaced most closely together, since this is the desired operating point in most practical systems.

When the antenna spacings are set to satisfy the maximum orthogonality condition of equation (4), the diagonal elements σᵢ of Σ for all the sub-channels are equal to \sqrt{N_{T}N_{R}/K}, wherein N_{T} and N_{R} are the numbers of transmit and receive antennas, respectively, and K is the number of spatial sub-channels. In other words, the gain of each sub-channel is increased by a spatial diversity gain (in dB) given by SDG 10[log₁₀(N_{T})+log₁₀(N_{R})−log₁₀(K)]. If the number of antennas is reduced (due to a hardware failure, for example), and the number of spatial sub-channels is reduced accordingly, the SDG of the remaining spatial sub-channels is unchanged.

### Dual-Mode Adaptive Orthogonalization of Sub-Channels

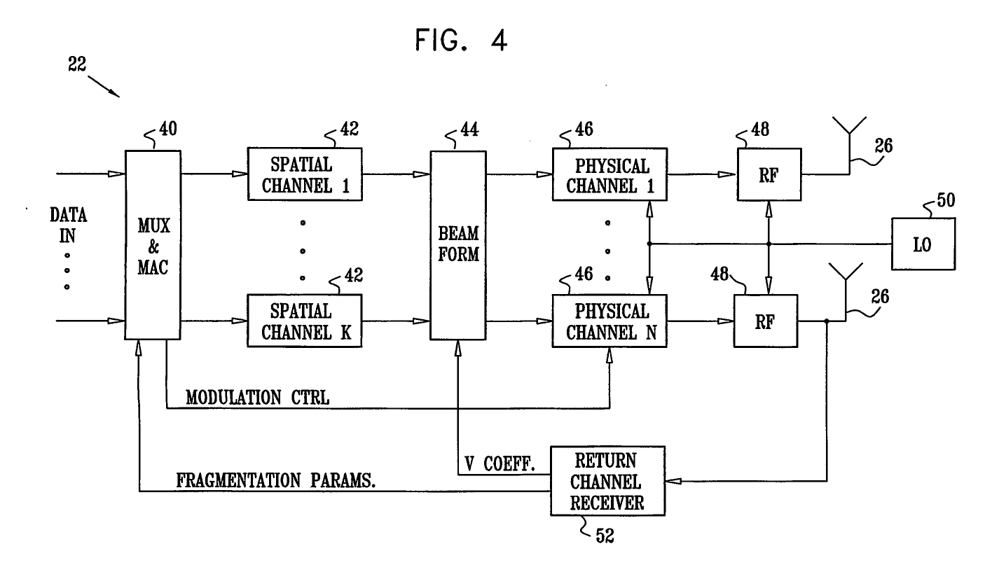

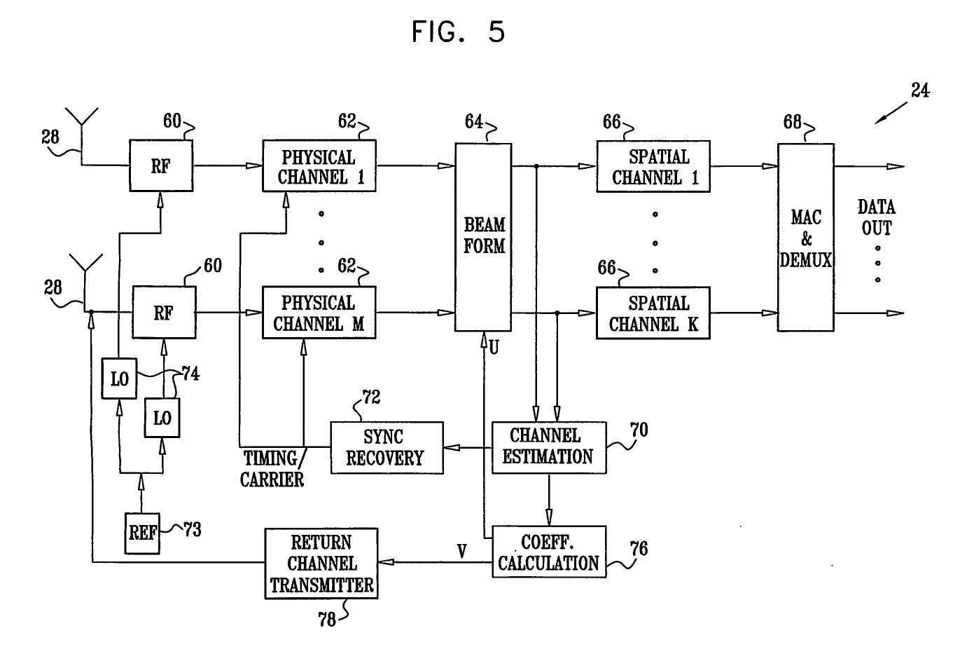

Reference is now made to FIGS. 4 and 5, which schematically show elements of transmitter 22 and receiver 24, respectively, in accordance with a preferred embodiment of the present invention. These elements are described briefly here, and are then reviewed in greater detail further below. The elements of transmitter 22 and receiver 24 that are shown in the figures are functional blocks, which may be implemented using dedicated hardware or, in certain cases, using a general-purpose microprocessor or digital signal processor with suitable software and/or firmware. The transmitter and receiver are divided into the functional blocks shown in the figures for the sake of conceptual clarity, and in practical implementations, groups of the blocks may be combined in a single circuit or component.

Transmitter 22 receives one or several streams of input data, which may be of substantially any type and format, such as TDM data or packet data. A media access control (MAC) unit 40 multiplexes the data streams together (in the case of multiple input streams), and then divides the data into multiple spatial sub-channels. As shown in the figure, there are K spatial sub-channels, K<min {MN}, wherein N is the number of transmit antennas 26, and M is the number of receive antennas 28. Each spatial sub-channel may carry a particular data stream, or alternatively, different data streams may be multiplexed onto a single spatial sub-channel, or a single data stream may be fragmented among multiple spatial sub-channels. The data to be transmitted over each of the sub-channels are encoded and framed by a spatial channel processor 42.

The spatial sub-channel signals output by spatial channel processors 42 are transformed into physical sub-channel signals by a beam former 44. The beam former applies the unitary matrix V, as determined by equation (3), to rotate the input signal vector x into x′=Vx. The elements of the vector x′ represent the respective physical sub-channel signals to be transmitted by each of transmit antennas 26. The physical sub-channel signals received by receiver 24 are then y′=Hx′+n. Rotation of the transmitted signals by V allows the received spatial sub-channel signals y to be recovered from y′ by a complementary rotation, y=Uy′ (ignoring the noise n, whose statistical behavior is unaffected by the unitary transformation U). It will then be observed that y and x are related by the simple expression y=Σx i.e., yᵢ=σᵢxᵢ, wherein σ₁, σ₂, . . . , σ_{K} are the diagonal elements of Σ.

The physical sub-channel signals output by beam former 44 are processed by respective physical channel processors 46 to generate modulated passband signals. Preferably, as described below, processors 46 apply OFDM to generate multi-carrier signals. Alternatively, however, substantially any suitable modulation scheme may be used. A radio frequency (RF) front end 48 for each physical sub-channel converts the modulated signals to analog form and up-converts the analog signals to the desired frequency for transmission by antennas 26. Preferably, all of physical channel processors 46 and RF front ends 48 share a common local oscillator (LO) 50 or other clock source.

Processing of the signals received by receiver 24 is the mirror image of the transmitter processing. Each receive antenna 28 is coupled to a RF front end 60, which down-converts, filters and digitizes the signals. The filters in front end 60 are set to reject any out-of-band interference. Physical channel processors 62 demodulate the signals, to generate the physical sub-channel signal data vector y′. A beam former 64 rotates y′ by the unitary matrix U, as described above, in order to separate out the elements of the vector of spatial sub-channel signals y. Each element yᵢ of y is fed to a respective spatial sub-channel processor 66, in order to decode and recover the original input data transmitted on each sub-channel by transmitter 22. A MAC unit 68 demultiplexes any data streams that were multiplexed onto each of the spatial sub-channels and reassembles any data streams that were fragmented among multiple sub-channels, so as to reconstruct the original, transmitted data streams.

Although it is theoretically possible to determine the matrices U and V a priori, based on geometrical considerations, as described above, in practical situations H typically varies from theoretical expectations. The exact distances between all the antennas may not be precisely known, and H may deviate from the simple form of equation (2) due to environmental factors, such as fading and multi-path effects. Therefore, to achieve optimal performance of system 20, with full decoupling of the spatial sub-channels, it is desirable to estimate H at receiver 24, and to adjust U and V accordingly. For this purpose, transmitter 22 preferably transmits training signals from each of transmit antennas 24 according to a predetermined training pattern.

A channel estimator 70 in receiver 24 analyzes the received training signals so as to determine the matrix element Hᵢⱼ for each pair of transmit and receive antennas. Most preferably, when a multi-carrier modulation scheme, such as OFDM, is used, the training signals comprise predetermined pilot signals, which are transmitted on each of the different carrier frequencies in turn. In this case, the channel estimator determines a specific value of Hᵢⱼ for each of the carrier frequencies. A coefficient analyzer 76 applies SVD to the matrices H determined by estimator 70 in order to calculate the elements of matrices U, Σ and V. The elements of matrices U and Σ are applied by beam former 64 in receiver 24. A return channel transmitter 78 conveys the elements of matrix V back to transmitter 22.

A return channel receiver 52 in the transmitter receives the elements of matrix V, and applies the elements in beam former 44. The return channel between transmitter 78 and receiver 52 may be carried between a single pair of antennas 28 and 26. Alternatively, the return channel may be conveyed over a larger subset of the antennas, or over all the antennas. In this way, the spatial diversity gain of the return channel is increased, thus ensuring reliable transmission of the matrix elements. (Further alternatively, although system 20 is described herein essentially as a simplex, unidirectional link, the principles of this system may similarly be applied to frequency duplex communications.) Preferably, during operation of system 20, coefficient analyzer 76 periodically checks and updates the values of U, Σ and V, and conveys the updated values of the elements of matrix V to transmitter 22 over the return channel.

In addition, coefficient analyzer 76 may convey the values of the diagonal elements σᵢ of matrix Σ over the return channel to transmitter 22. As noted above, these elements represent the respective gains of the individual spatial sub-channels. The data-carrying capacity of each sub-channel is generally proportional to its gain. Thus, MAC unit 40 of transmitter 22 may use the sub-channel gains in determining how to divide the input data among the spatial sub-channels, in proportion to the sub-channel capacities.

A synchronization recovery circuit 72, coupled to channel estimator 70, senses any deviation between the clock and carrier frequencies used by receiver 24 and those of transmitter 22. The clock correction determined by circuit 72 is used to correct the timing of analog/digital (A/D) converters in physical channel processors 62. The carrier correction determined by circuit 72 is used to drive the demodulation of the received signals by physical channel processors 62. The same timing and carrier corrections are preferably used by all the physical sub-channels. Similarly, a common frequency reference circuit 73 is used to drive local oscillators (LOs) 74 for all of RF front ends 60.

In practical applications of system 20, the elements of the channel transfer function matrix H may change quickly, due to changes in the weather, antenna movement or moving scatterers along the transmission path. The mechanism for updating the values of V applied by transmitter 22 may not be fast enough to keep up with these changes and maintain optimal orthogonality of the spatial sub-channels. Therefore, following the initial SVD analysis described above, coefficient analyzer 76 preferably performs continual one-sided channel orthogonalization in order to rapidly update the elements of U applied by beam former 64 in response to small changes in H, thus avoiding the need to continually update the elements of V. This approach is referred to herein as “dual-mode orthogonalization.”

Preferably, coefficient analyzer 76 applies the well-known technique of QR decomposition in order to update the elements of U. The vector of physical sub-channel signals received by beam former 64 is given by IV, which is exactly equal to UΣ as long as H does not vary (as can be seen in equation (3)). To correct for small variations in H, the coefficient analyzer performs the decomposition HV=QR, wherein Q is a unitary matrix, and R is an upper triangular matrix. Initially, immediately after the coefficients of V have been updated, R is diagonal (i.e., the off-diagonal elements in the upper triangle of R are zero or nearly zero), and Q approaches the U matrix as calculated by the SVD method.

As H changes, the off-diagonal elements of R, obtained from the QR decomposition of HV, gradually increase. Since R is an upper diagonal matrix, it is easily inverted to give R⁻¹ The elements of U applied by beam former 64 are updated, based on the updated Q matrix, Q′, to the values given by U=R⁻¹Q′. Beam former 64 is thus able to separate the spatial sub-channels accurately out of the physical sub-channel signals, despite the error remaining in the rotation V applied by beam former 44 in the transmitter. Any remaining error in V affects only the diversity gain, and not the separation of the spatial sub-channels by receiver 24. Therefore, imprecise values of the transmitter (V) beam-forming coefficients can be tolerated, and the these coefficients may be updated infrequently, relative to the receiver (U) coefficients, without seriously degrading system performance.

As the error in HV grows, however, the data capacity of the wireless link of system 20 may decrease, due to the reduced spatial diversity gain of the spatial sub-channels. In order to return the system to its full capacity, coefficient analyzer 76 preferably determines new values of the elements of U and V from time to time, and conveys the new values of V over the return channel to transmitter 22. The transmitter signals the receiver to indicate that it has received the new values. Immediately thereafter, the transmitter implements the new V coefficients in beam former 44, and the receiver at the same time implements the new U coefficients. If the transmitter does not acknowledge receipt of the new values, the receiver sends them again until acknowledgment is received.

As a further alternative to the schemes described above, the receiver may perform only one-sided analysis, using QR decomposition, for example, without returning coefficients to the transmitter. In this case, transmitter 22 no longer delivers separated spatial sub-channels. Rather, each transmit antenna 26 delivers a data stream.

Although the examples shown above are based on a symmetrical system, with equal numbers of transmit and receive antennas, and the same number of spatial sub-channels, the principles of dual-mode orthogonalization are equally applicable to non-symmetric cases. The number of spatial sub-channels may intentionally be set to be less than the maximum that will be supported by the wireless link, in order to provide increased spatial diversity gain on the spatial sub-channels. Alternatively, the number of spatial sub-channels may be reduced due to system stress, such as when one of the physical sub-channels becomes inoperative in the transmitter or the receiver, or when the channel transfer function H is singular or near-singular. These stress conditions may be detected by channel estimator 70 upon analysis of the training signals received by receiver 24.

Table I below gives the number of rows and columns in matrices V^{t}, H and U, as defined by equation (3) above, for the general case in which the numbers of the antennas and sub-channels are not necessarily equal:

TABLE I
SVD MATRIX RANKS

| Matrix | Rows | Columns |
|---|---|---|
| V^{t} | Number of useful | Number of available Tx antennas |
| | sub-channels | |
| H | Number of available Tx | Number of available Rx antennas |
| | antennas | |
| U | Number of available Rx | Number of useful sub-channels |
| | antennas | |

For example, with four transmit antennas, but only three receive antennas operative, system 20 will have (at most) three available spatial sub-channels, and coefficient processor 76 will determine the elements of the applicable matrices according to equation (5):

$$[ \begin{matrix}o \\ o \\ o\end{matrix} ] = [ \begin{matrix}o & o & o \\ o & o & o \\ o & o & o\end{matrix} ] \cdot [ \begin{matrix}o & o & o & o \\ o & o & o & o \\ o & o & o & o\end{matrix} ] \cdot [ \begin{matrix}o & o & o \\ o & o & o \\ o & o & o \\ o & o & o\end{matrix} ] \cdot [ \begin{matrix}o \\ o \\ o\end{matrix} ] \\ \underline{y} = U * H * {V}^{t} * \underline{x} \qquad ( 5 )$$

### Data Encoding and Modulation

As noted above, MAC unit 40 of transmitter 22 may receive one or more TDM data feeds (such as a SONET OC-3 or OC-12, or a SDH STM-1 or STM-4 link), or packet data feeds, or both. The MAC unit splits the input data that it receives among the available spatial sub-channels. Different sub-channels may have different data rates, and the MAC unit sets the modulation of each sub-channel according to these data rates.

For each sub-channel, MAC unit 40 divides the input data into frames, of fixed or variable length, and adds a header to each frame. Typically, the MAC header includes information such as frame length, type, serial number, service level and a dedicated error correction field. Different types of frames may be multiplexed together into a single stream by the MAC unit for transmission over a given spatial sub-channel, including management and control frames, as well as data frames. When the data feed contains packet data, each MAC frame may contain one or more packets (along with the original packet headers). The serial number inserted in the MAC header enables MAC unit 68 in receiver 24 to rearrange the data it has received, if necessary, in the order in which MAC unit 40 transmitted it.

The error correction field in the MAC header is used by MAC unit 68 in receiver 24 to correct errors that may occur in the header, which otherwise could cause loss of the entire frame. As a result, the inherent bit error rate of the input data stream is not increased by loss of frames in the course of transmission over the wireless link of system 20.

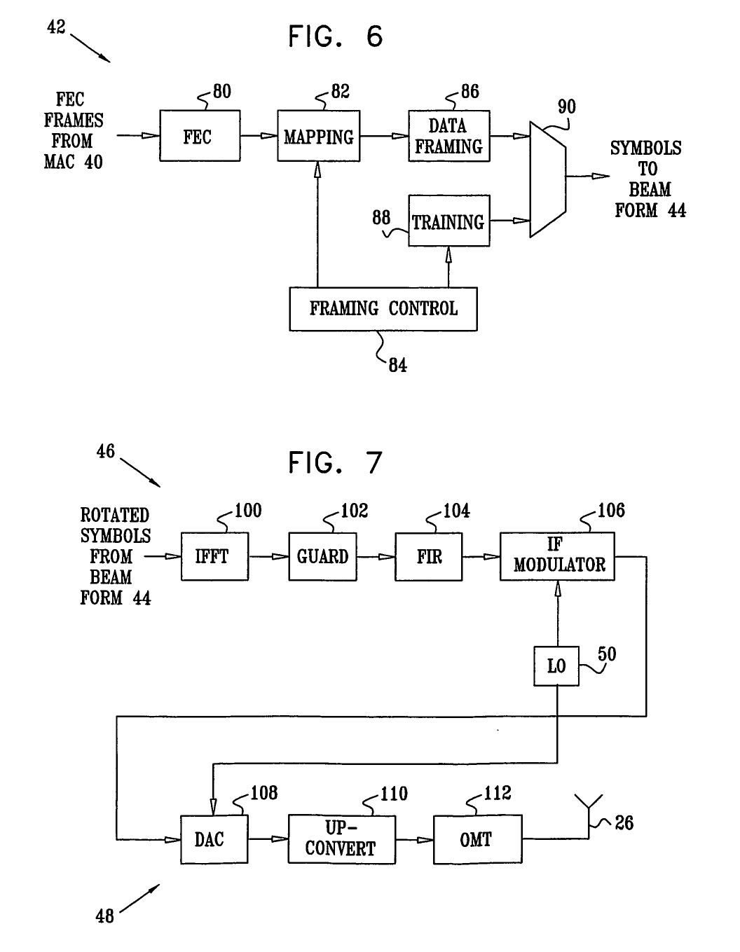

FIG. 6 shows details of one of spatial channel processors 42 in transmitter 22, in accordance with a preferred embodiment of the present invention. MAC unit 40 maps the MAC frames that it generates into forward error correction (FEC) blocks of fixed length. Since the MAC frames may be of variable size, a given MAC frame may be divided among multiple FEC blocks, or a given FEC block may contain parts or all of a number of MAC frames. A FEC encoder 80 adds a header to each FEC block that marks the beginning of each MAC frame in the block.

FEC encoder 80 also encodes each block with redundant bits, as is known in the art, for use by receiver 24 in correcting bit errors that may occur in transmission. The FEC encoder in each spatial sub-channel may have a different coding rate, depending on the assigned quality of service (QoS), the data rate and the gain margin of the sub-channel.

A mapper 82 maps groups of bits in the encoded data stream to symbols in a predetermined constellation. Preferably, a quadrature amplitude modulation (QAM) constellation is used, with a variable constellation size determined by a framing controller 84. When transmitter 22 uses multi-carrier modulation, such as OFDM, mapper 82 generates QAM symbols to transmit on all the sub-carrier frequencies that are in use. The number of sub-carriers used is preferably equal for all spatial sub-channels. Most preferably, although not necessarily, the FEC coding rate and constellation sizes are chosen so that all the spatial sub-channels operate at the same symbol rate. A data framer 86 frames the multi-carrier symbols for conversion to the time domain, padding the frames with zeroes at the edges of the spectrum in order to provide a band margin, as is known in the art.

A training signal generator 88 provides a predetermined sequence of training symbols, which are interspersed with the data symbols at fixed intervals by a multiplexer 90. The training symbols are used by receiver 24 in calculating and updating the elements of the channel transfer function matrix H, as described above. Typically, to reduce transmission overhead (and thus maintain a high payload data rate over the wireless link), the duty cycle of the training symbols is low, compared to the data symbols.

The training symbols are preferably chosen so that training signals are transmitted by all transmit antennas 26 at the same time, but no more than one antenna transmits on any given sub-carrier at any given time. Preferably, each training symbol causes each of the transmit antennas to transmit pilot tones on a certain, predetermined set of the OFDM sub-carriers. The sets of sub-carriers are scattered among the antennas from one training symbol to the next, according to a known pattern, so that after a certain number of training symbols, every antenna will have transmitted training signals on all the sub-carriers. Receiver 24 knows the pattern of sub-carrier allocation and is thus able, upon receiving each training signal, to identify which antenna has transmitted each of the pilot tones. It is then a straightforward matter for the receiver to compute, and subsequently to update, all the elements of H for each of the different sub-carriers.

FIG. 7 is a block diagram that schematically illustrates one of physical channel processors 46 with its RF front end 48, in accordance with a preferred embodiment of the present invention. The design shown in this figure assumes that a multi-carrier modulation scheme, such as OFDM, is used. The stream of symbols output by spatial channel processors 42 are rotated according to the elements of matrix V (individually for each sub-carrier) by beam former 44. The rotated symbols are then input to an Inverse Fast Fourier Transform (IFFT) processor 100, which transforms the symbols to time-domain signals. A guard adder 102 adds a cyclic prefix to each symbol, as is known in the art, in order to protect against delay spreading of the transmitted signals. The signals are then up-sampled, typically by a factor of four, using a finite impulse response (FIR) filter, and are digitally modulated to an intermediate frequency (IF) by an IF modulator 106.

The real part of the IF signal is converted to the analog domain by a digital/analog converter (DAC) 108. As noted above, the IF modulation and digital/analog conversion in all of physical channel processors 46 are preferably timed by the same local oscillator 50. A mixer 110 up-converts the IF signals to the actual RF transmission frequency.

Preferably, a orthogonal mode transducer (OMT) 112 polarizes the output of each physical sub-channel in either a vertical or horizontal direction. (Alternatively, clockwise and counterclockwise polarizations may be used.) Typically, the physical sub-channels are equally divided between the two polarization directions. Cross-polarized channels can be transmitted by adjacent antennas even without spatial multiplexing, with the polarization providing 15 dB of protection from mutual interference. Thus, cross-polarization of the physical sub-channels in system 20 allows the wireless link capacity to be substantially increased. Channel estimator 70 and coefficient analyzer 76 determine the elements of H, as described above, in the same manner regardless of the polarization (or absence of polarization) of the physical sub-channels.

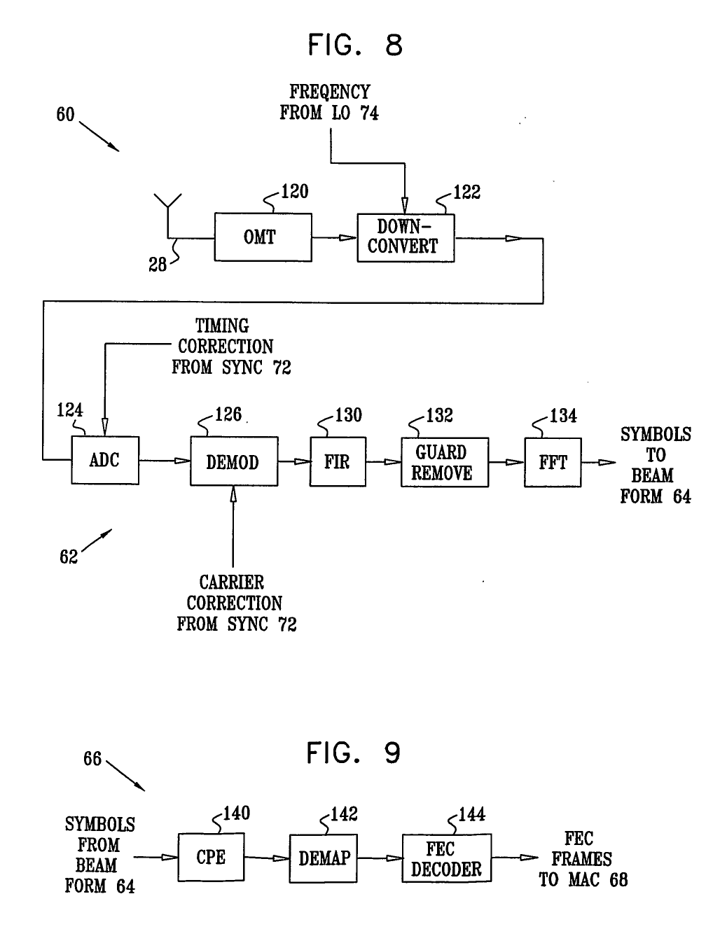

FIG. 8 is a block diagram that schematically illustrates one of physical channel processors 62 in receiver 24 with its RF front end 60, in accordance with a preferred embodiment of the present invention. Assuming the transmitted signals are polarized, an OMT 120 selects the polarization of the RF signals to be received from each antenna 28. A down-converter 122 down-converts the RF signals to IF, and the IF signals are digitized by an analog/digital converter (ADC) 124. As noted above, the ADC preferably receives its clock from synchronization recovery circuit 72, which is shared by all the physical sub-channels.

An IF demodulator 126 demodulates the IF signal down to baseband. The demodulation frequency is controlled by a carrier correction signal from synchronization recovery circuit 72. This arrangement enables the demodulator to compensate for phase variations in the physical sub-channel, while maintaining the same frequency among all the receiver circuits. The use of common clock and carrier correction signals for all the physical sub-channels provides the best timing performance, in terms of achieving optimal mutual synchronization of the sub-channels. Alternatively, separate clock sources and timing signals may be used for the different physical sub-channels.

A FIR filter 130 filters the baseband signals to remove any out-of-band interference. A guard remover 132 recognizes and strips off the cyclic prefixes from the time-domain signals, following which a FFT processor 134 converts the signal to frequency-domain symbols. The length of the FFT depends on the widths of the sub-carrier frequency bands and the fading pattern. Typically, at frequencies in the range of 5 GHz, the FFT should have a length of 128 to 256 samples, whereas at higher frequencies, at which multi-path effects are negligible, a shorter FFT (64 to 128 samples) is preferable.

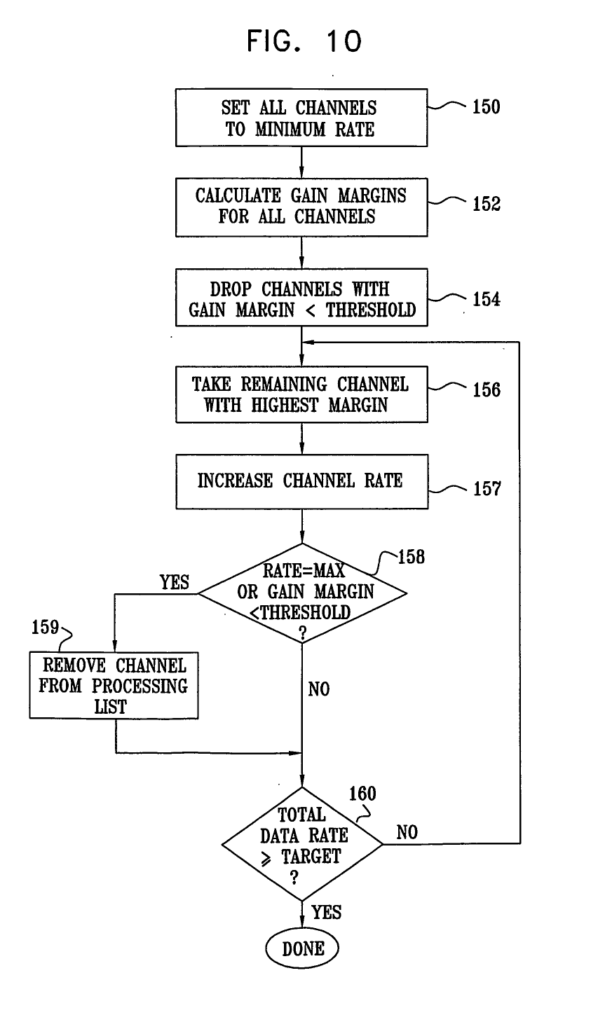

FIG. 9 is a block diagram that schematically shows details of one of spatial channel processors 66, in accordance with a preferred embodiment of the present invention. The frequency-domain symbols output by FFT processors 134 from all the physical sub-channels are rotated by beam former 64 to provide the input symbols to each of the spatial sub-channels, as described above. A common phase error (CPE) rotator 140 removes the common phase noise in each sub-channel, as is known in the art of OFDM receivers. A demapper 142 converts the symbols back into a bit stream, which includes error correction coding, such as turbo product coding, that was introduced by FEC encoder 80. A FEC decoder 144 processes this bit stream to recover the original MAC payload frames, which it passes to MAC unit 68 for final processing and output.

### Adaptive Modulation and Fault Protection

Although in the ideal case described above, all the spatial sub-channels in system 20 have the same capacity and quality parameters, in practice there is frequently a deviation from this ideal behavior. Changes in channel conditions, due to rain, for example, or multi-path effects, may cause degradation in the signal/noise ratio (and thus in the gain margin and data capacity) of one or more sub-channels. Component failures in the transmitter or receiver may also affect the number and quality of available sub-channels. When such changes occur, it may be necessary to redistribute the data payload among the sub-channels.

In some cases, it may actually be desirable to adjust transmitter 22 and receiver 24 intentionally so that different sub-channels have different capacities and gain margins. Such adjustment may be achieved by selecting non-optimal antenna spacing, and adjusting the beam-forming coefficients accordingly to maintain link capacity near the theoretical limit. Different modulation and coding rates may be used on different sub-channels, based on the respective gain margins.

The sub-channel capacities may be matched to the needs of different types of data streams carried by the wireless link. For example, TDM network connections, such as SONET and SDH links, require fixed payload capacity, with strict bounds on BER. On the other hand, for packet data links, such as Ethernet or ATM, the capacity needs may vary, and BER may be traded off against increased transmission speed and low latency. When MAC unit 40 receives heterogeneous inputs (such as a TDM input and a packet input), it may match the inputs to spatial sub-channels that meet their particular capacity and quality requirements. When a multi-carrier modulation scheme is used, MAC unit 40 may also assign a portion of the sub-carriers on a given spatial sub-channel to carry one of its input data stream and a different portion of the sub-carriers on the sub-channel to carry another input data stream.

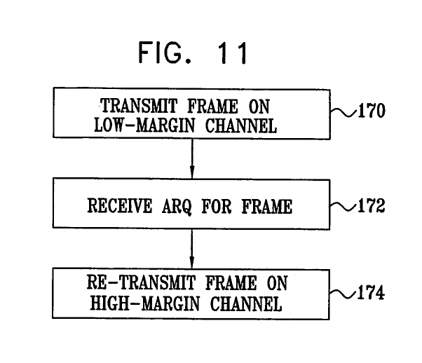

FIG. 10 is a flow chart that schematically illustrates a method for adaptively setting coding and modulation parameters of different spatial sub-channels in system 20, in accordance with a preferred embodiment of the present invention. This method is applied by MAC unit 40 in order to set the sub-channel parameters so that the wireless link carries as much data as is required, while maintaining the maximum possible gain margin on each sub-channel. The gain margin is defined as the difference between the current sub-channel signal/noise ratio (SNR), which depends on the modulation and coding parameters, and the SNR corresponding to the maximum permitted BER.

The method of FIG. 10 begins after transmitter 22 and receiver 24 have carried out a training sequence and set the elements of matrices U and V so as to define the spatial sub-channels that are in use. All the sub-channels are then set to their minimum data rates, at an initialization step 150. The rate of each sub-channel is determined by the modulation level of mapper 82, i.e., by the choice of symbol constellation size, and by the coding level of FEC encoder 80. The minimum data rate corresponds to the smallest possible constellation and the highest coding gain. Channel estimator 70 in receiver 24 measures the gain margins for all the spatial sub-channels, at a margin measurement step 152. Any sub-channels whose gain margin is below the minimum threshold are dropped, at a channel elimination step 154. The channel transfer function H and matrices U and V may then be recalculated, as described above with reference to Table I and equation (5), in order to redistribute the capacity of the dropped sub-channel among the remaining sub-channels.

Of the sub-channels remaining at this point, MAC unit 40 selects the sub-channel with the highest gain margin, at a channel selection step 156. It instructs sub-channel processor 42 of the selected channel to increase the sub-channel transmission rate, at a rate increase step 157. As noted above, the rate may be increased by enlarging the symbol constellation or reducing the coding gain, or both. In multi-carrier modulation schemes, the symbol constellation may be enlarged for all the sub-carriers or only for certain sub-carriers that are found to have high gain margins.

Channel estimator 70 measures the gain margin of the selected sub-channel again at the increased data rate, at a margin checking step 158. If the gain margin has dropped below the threshold, then the rate of the selected sub-channel is left at its previous value, and the sub-channel is dropped from further consideration, at a channel elimination step 159. Similarly, if the sub-channel transmission rate has reached its maximum allowed value, the selected sub-channel will not be processed any further.

After adjusting the rate of the selected sub-channel, MAC unit 40 checks the aggregate data rate of all the operative sub-channels, at a data rate checking step 160. As long as the aggregate data rate has not yet exceeded the total target capacity for the wireless link, the MAC unit returns to step 156, selecting the next sub-channel remaining on the adjustment list with the highest gain margin. This new selected sub-channel is processed in steps 157, 158 and 159, as described above. When the MAC unit finds at step 160 that the aggregate target capacity has been met, the process terminates, and normal communication between transmitter 22 and receiver 24 proceeds at the sub-channel rates that have been set. If receiver 24 determines that conditions have changed, however, it may reinitiate the process of FIG. 10 in order to readjust the sub-channel rates.

Preferably, system 20 is designed with sufficient excess gain so that the system can continue to operate at its target capacity even in the event of component failure, rain or deep fade (gain reduction) due to environmental conditions, such as multipath effects. Thus, at the sub-channel rates determined by the method of FIG. 10 under good conditions (clear weather), the sub-channels will typically have gain margins substantially in excess of the minimum threshold. Little or no readjustment of channel parameters should be required when conditions worsen.

When a component failure occurs, the channel transfer function H may be recalculated to account for the reduced number of transmit or receive antennas that are in operation. Alternatively, the previous estimates of the elements Hᵢⱼ may simply be used in a new H matrix of reduced rank. The number of spatial sub-channels may have to be reduced so that it is no greater than the number of remaining antennas on both the transmit and receive sides of the link. MAC unit 40 must then reallocate its data input among the reduced number of spatial sub-channels. Under these circumstances, it is typically necessary to increase the individual data rates of the spatial sub-channels (by using a larger constellation or lower coding gain, for example) so that the aggregate data rate still meets the overall target capacity of the wireless link. For this reason, system 20 is preferably designed so that even when one physical sub-channel is lost, the sub-channels remaining are capable of sustaining the required capacity with a gain margin no less than the minimum threshold.

System 20 thus provides a sort of active redundancy, which makes it possible for the transmitter and receiver to be positioned relatively far apart due to the high gain margin that the system normally provides. By comparison, in wireless link systems known in the art, redundant terminals (with or without extra antennas) may be provided, but are not used except in the case of failure. The distance between the transmitter and receiver typically cannot be any greater than the range over which the active antennas can communicate in bad weather. The “redundant” transmit and/or receive circuits in system 20, however, are active at all times, thus providing an added fading margin that increases the bad-weather range of the link. The link rate in system 20 must be reduced only in the unlikely occurrence of simultaneous circuit (or antenna) failure and bad weather.

FIG. 11 is a flow chart that schematically illustrates a method for automatic retransmission of data frames in system 20, in accordance with a preferred embodiment of the present invention. Whenever MAC unit 68 in receiver 24 receives a FEC block in which not all bit errors have been corrected, the MAC unit may request retransmission of the block by submitting an automatic repeat request, (ARQ) over the return channel to transmitter 22. System 20 preferably has sufficient total data capacity to handle these requests. In this way, the system can achieve a zero total error rate even with low SNR.

The capacity of system 20 may be optimized by using a high-speed spatial sub-channel with low gain margin for normal data transmission, while using a higher-reliability (high gain margin) sub-channel for ARQ retransmission. Thus, as illustrated in FIG. 11, MAC unit 40 in transmitter 22 normally sends data frames over a low-margin spatial sub-channel, at a normal transmission step 170. When MAC unit 68 in receiver 24 finds an uncorrected error in a FEC block, it sends an ARQ message to MAC unit 40 over the return channel, at an ARQ step 172. MAC unit 40 responds by retransmitting the requested block on a different, high-margin channel, at a retransmission step 174.

### Alternative Link Configurations

Although system 20 is depicted above as a symmetrical, point-to-point system, the principles of the present invention are also applicable to other wireless network topologies.

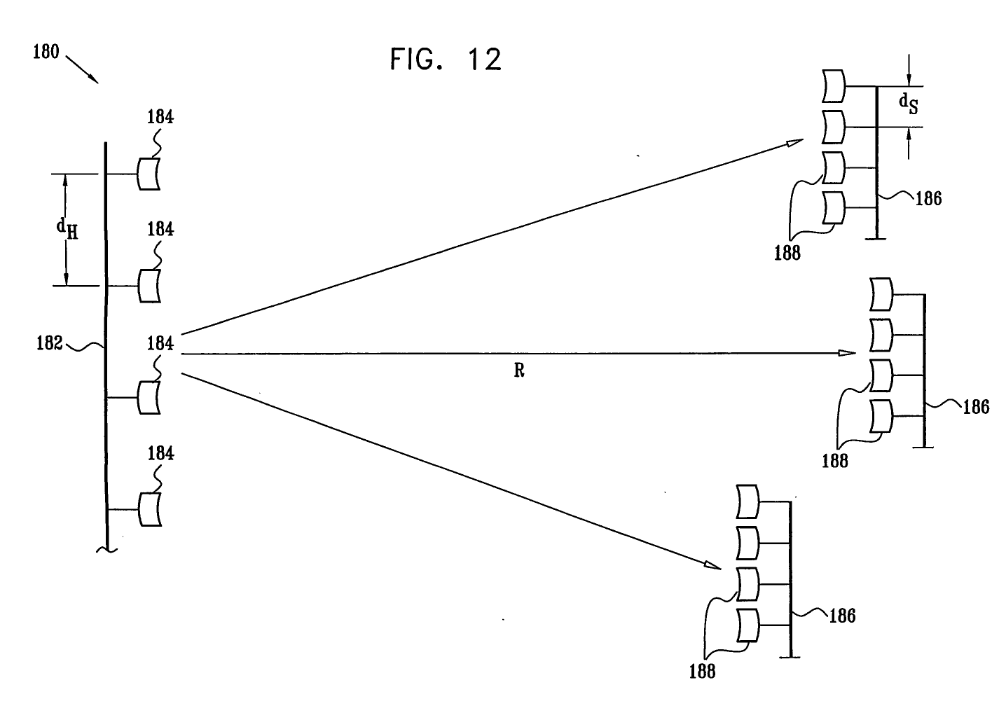

FIG. 12, for example, schematically illustrates a wireless communication system 180 having a star topology, in accordance with a preferred embodiment of the present invention. A hub unit 182, having multiple hub antennas 184, transmits data to and/or receives data from multiple spoke units 186, having spoke antennas 188. Typically, for convenience of deployment and cost savings, the mutual spacing of the hub antennas, d_{H}, is greater than the spacing of the spoke antennas, d_{S}, but substantially any spacings that meet the criterion of equation (4) may be used. System 180 may be a part of a larger star network, in which spoke units 186 communicate with other wireless units (not shown) farther from the hub, by means of point-to-point connections.

System 180 may be configured as either a point-to-multipoint network or as a group of multiple point-to-point links. In the point-to-multipoint configuration, hub unit 182 may serve multiple spoke units 186 simultaneously by TDM or by frequency division multiplexing (FDM). In the multiple point-to-point configuration, beam forming is used to separate the spatial sub-channels that are directed to the different spoke units.

The principles of the present invention may also be applied to other wireless network topologies. For example, multi-antenna transmitters and receivers in accordance with the present invention may be used as nodes of a SONET or SDH ring, or of a bi-directional resilient packet ring (RPR). Such ring types are known in the art, but generally use wires or optical fibers to connect the network nodes. A hybrid ring network may also be constructed using wires or optical fibers for some of the node-to-node connections in the ring, and wireless links of the type shown here for other connections.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Wireless communication apparatus, comprising:
a transmitter, which comprises a first plurality of transmit antennas mutually separated by a first spacing, and which is configured to transmit signals via the transmit antennas over multiple spatial sub-channels, the signals having respective phases; and
a receiver, which comprises a second plurality of receive antennas mutually separated by a second spacing, and which is configured to receive the signals over the multiple spatial sub-channels via the receive antennas,
wherein the first and second spacings are chosen so as to maximize a linear independence of the respective phases of the signals received at the receive antennas.

2-4. (canceled)

5. Apparatus according to claim 1, wherein the transmitter is adapted to modulate the signals so as to convey respective data to the receiver over each of the spatial sub-channels, and wherein the receiver comprises a receive beam former, which is coupled to process together the signals received by the receive antennas so as to separate out the respective data conveyed over each of the spatial sub-channels.

6. Apparatus according to claim 5, wherein the transmitter comprises a transmit beam former, which is coupled to generate the signals to be transmitted by combining the respective data to be conveyed over the multiple spatial sub-channels so as to orthogonalize the spatial sub-channels.

7. (canceled)

8. Apparatus according to claim 5, wherein the receiver comprises a channel estimator, which is adapted to estimate a channel transfer function between the transmit antennas and the receive antennas, and to determine, responsive to the channel transfer function, receive coefficients to be applied by the receive beam former in processing the signals received by the receive antennas.

9. Apparatus according to claim 8, wherein the transmitter comprises a transmit beam former, which is coupled to generate the signals to be transmitted by combining the respective data to be conveyed over the multiple spatial sub-channels, and wherein the channel estimator is further adapted to determine, responsive to the channel transfer function, transmit coefficients, and to convey the transmit coefficients to the transmitter for application by the transit beam former in processing the respective data.

10-16. (canceled)

17. Apparatus according to claim 8, wherein the transmitter is adapted to transmit a training signal to the receiver in predetermined training intervals, for use by the channel estimator in estimating the channel transfer function, such that during the training signal, a known transmission pattern is transmitted by each of the transmit antennas at predetermined times.

18-22. (canceled)

23. Apparatus according to claim 8, wherein the signals transmitted from the transmitter to the receiver comprise multi-carrier signals, having multiple carrier frequencies, and wherein the channel estimator is adapted to estimate the channel transfer function and determine the coefficients respectively for each of the carrier frequencies.

24. Apparatus according to claim 5, wherein the signals transmitted by the transmitter to the receiver comprise multi-carrier signals, having of multiple carrier frequencies, and wherein the beam former is adapted to separate out the respective data conveyed over each of the spatial sub-channels by processing together the signals received on each of the carrier frequencies, separately from the signals received on the other carrier frequencies.

25. Apparatus according to claim 1, wherein the first plurality comprises a first number N of the transmit antennas, and the second plurality comprises a second number M of the receive antennas, and wherein the multiple spatial sub-channels comprise a third number K of the spatial sub-channels, such that K is less than or equal to a minimum of M and N.

26. Apparatus according to claim 25, wherein K is selected so that each of the spatial sub-channels has a desired spatial diversity gain, which is proportional to M and N, and inversely proportional to K.

27-28. (canceled)

29. Apparatus according to claim 1, wherein the transmitter comprises:
multiple modulator circuits, which are coupled respectively to drive the transmit antennas; and
a single timing circuit, which is coupled to provide timing and reference signals to all the modulator circuits.

30. Apparatus according to claim 1, wherein the receiver comprises:
multiple demodulator circuits, which are coupled respective to receive and process the signals from the receive antennas; and
a single synchronization circuit, which is coupled to provide timing and reference signals to all the demodulator circuits.

31. Apparatus according to claim 1, wherein the transmitter comprises transmit orthogonal mode transducers (OMTs) respectively coupled to the transmit antennas, so that a first subset of the transmit antennas transmits the signals with a first polarization, and a second subset of the transmit antennas transmits the signals with a second polarization, orthogonal to the first polarization, and
wherein the receiver comprises receive OMTs respectively coupled to the receive antennas, so that a third subset of the receive antennas receives the signals with the first polarization, and a fourth subset of the receive antennas receives the signals with the second polarization.

32. Apparatus according to claim 1, wherein each of the spatial sub-channels is characterized by a respective signal/noise ratio (SNR), and wherein the transmitter is adapted to modulate the signals so as to convey respective data to the receiver over each of the spatial sub-channels at a respective sub-channel data rate that is determined by the respective SNR.

33. Apparatus according to claim 32, wherein the transmitter is coupled to receive an input data stream, and is adapted to distribute the input stream among the spatial sub-channels responsive to the respective sub-channel rate of each of the spatial sub-channels.

34-39. (canceled)

40. Apparatus according to claim 32, wherein the transmitter comprises multiple data modulators, each of which is coupled to generate the signals for transmission over a respective sub-channel among the multiple spatial sub-channels, and wherein the transmitter is adapted to set a modulation rate of each of the data modulators responsive to the SNR of the respective sub-channel.

41-44. (canceled)

45. Apparatus according to claim 1, wherein the spatial sub-channels are characterized by respective sub-channel data rates and gain margins, and wherein the sub-channel rates are chosen so as achieve a target aggregate data rate for all the spatial sub-channels together, and
wherein the transmit and receive antennas are positioned so that in the event of either a failure associated with one of the antennas or a degradation of the signals, the apparatus continues to provide at least the target aggregate data rate with gain margins greater than zero on all the spatial sub-channels that are still operative.

46-50. (canceled)

51. Wireless communication apparatus, comprising:
a transmitter, which comprises a first number N_{T} of transmit antennas mutually separated by a first spacing d_{T}, and which is configured to transmit signals via the transmit antennas over multiple spatial sub-channels at a carrier wavelength λ; and
a receiver, which comprises a second number N_{R} of receive antennas mutually separated by a second spacing d_{R}, and which is positioned at a predetermined distance R from the transmitter and is configured to receive the signals over the multiple spatial sub-channels via the receive antennas,
wherein the wavelength, distance and first and second spacings are chosen so that a first value equal to d_{T}d_{R} is between approximately one third of and three times a second value equal to λR/N, wherein N is a maximum of N_{T} and N_{R}.

52. Apparatus according to claim 51, wherein the wavelength, distance and first and second spacings are chosen so that the first and second values are approximately equal.

53-70. (canceled)

71. A method for wireless communication, comprising:
transmitting signals over multiple spatial sub-channels using a first plurality of transmit antennas having a first spacing therebetween;
receiving the signals using a second plurality of receive antennas having a second spacing therebetween; and
positioning the transmit and receive antennas, including setting at least one of the first and second spacings, so as to maximize a linear independence of the respective phases of the signals received at the receive antennas.

72-140. (canceled)
